(19) United States
(12) Patent Application Publication
(10) Pub. No.: US 2026/0187696 A1
(43) Pub. Date: Jul. 2, 2026

(54) ELECTRONIC DEVICE AND METHOD OF OPERATING THE SAME

(71) Applicant: SAMSUNG ELECTRONICS CO., LTD., Suwon-si (KR)

(72) Inventors: Jongcheol PARK, Suwon-si (KR); Jongil CHOI, Suwon-si (KR); Yonghun JANG, Suwon-si (KR)

(73) Assignee: SAMSUNG ELECTRONICS CO., LTD., Suwon-si (KR)

(21) Appl. No.: 19/385,727

(22) Filed: Nov. 11, 2025

Related U.S. Application Data
(63) Continuation of application No. PCT/KR2025/017089, filed on Oct. 24, 2025.

(30) Foreign Application Priority Data
Dec. 11, 2024 (KR) 10-2024-0184141

(51) Int. Cl. G06Q 30/0601

(52) U.S. Cl. CPC G06Q 30/0631

(57) ABSTRACT

Provided is a method of operating an electronic device. The method may include obtaining, based on a user input, a list based on a plurality of pieces of recommended content obtained from a first artificial intelligence (AI) model; obtaining, based on the list, a title associated with the list from a second AI model; obtaining, based on the title, an image from a third AI model; and providing the list, the title associated with the list, and the image.

### CROSS-REFERENCES TO RELATED APPLICATIONS

This application is a continuation of International Application No. PCT/KR 2025/017089 filed on Oct. 24, 2025, with the Korean Intellectual Property Office, which claims priority to Korean Patent Application No. 10-2024-0184141 filed on Dec. 11, 2024, with the Korean Intellectual Property Office, the disclosures of which are incorporated herein by reference in their entireties.

### TECHNICAL FIELD

The disclosure relates to an electronic device for providing recommended content, and a method of operating the electronic device.

### BACKGROUND

Recently, generative artificial intelligence as a technology that uses artificial intelligence to generate new data based on input data has risen. The generative artificial intelligence is a technology that has been trained on the structure and patterns of huge amount of data and generates new synthetic data based on input data. The generative artificial intelligence is capable of generating human-level outputs over a wide range of tasks related to text, images, speech, video, music, or the like.

There is an increasing demand for technologies that provide users with new content experiences by providing recommended content by using the generative artificial intelligence.

### SUMMARY

According to an aspect of the disclosure, a method of operating an electronic device is provided. The method may include obtaining, based on a user input, a list based on a plurality of pieces of recommended content obtained from a first artificial intelligence (AI) model; obtaining, based on the list, a title associated with the list from a second AI model; obtaining, based on the title, an image from a third AI model; and providing the list, the title associated with the list, and the image.

According to an aspect of the disclosure, an electronic device is provided. The electronic device may include a communication interface, at least one processor including processing circuitry, and memory storing instructions, and the instructions may be executed by the at least one processor individually or collectively. The electronic device may obtain, based on a user input, a list based on a plurality of pieces of recommended content obtained from a first artificial intelligence (AI) model; obtain, based on the list, a title associated with the list from a second AI model; obtain, based on the title, an image from a third AI model; and provide the list, the title associated with the list, and the image.

According to an aspect of the disclosure, a non-transitory computer readable medium storing instructions may be provided. The instructions, when executed by at least one processor, may cause the at least one processor to obtain, based on a user input, a list based on a plurality of pieces of recommended content obtained from a first artificial intelligence (AI) model; obtain, based on the list, a title associated with the list from a second AI model; obtain, based on the title, an image from a third AI model; and provide the list, the title associated with the list, and the image.

### BRIEF DESCRIPTION OF THE DRAWINGS

FIG. 1 is a diagram for illustrating a scenario in which an electronic device provides recommended content, according to an embodiment of the disclosure.

FIG. 2 is a diagram illustrating a system according to an embodiment of the disclosure.

FIG. 3 is a diagram illustrating a system according to an embodiment of the disclosure.

FIG. 4 is a flowchart for describing an example process by which an electronic device provides recommended content, according to an embodiment of the disclosure.

FIG. 5 is a diagram for describing an example process by which an electronic device uses a generative artificial intelligence (AI) model, according to an embodiment of the disclosure.

FIG. 6 is a diagram for describing an example process by which an electronic device obtains a plurality of pieces of recommended content by inputting a user input to a first AI model, according to an embodiment of the disclosure.

FIG. 7 is a diagram for describing an example process which an electronic device obtains a plurality of pieces of recommended content by inputting a user input and target viewer information to a first AI model, according to an embodiment of the disclosure.

FIG. 8 is a diagram for describing an example scenario in which an electronic device compares recommended content with a content database, according to an embodiment of the disclosure.

FIG. 9 is a diagram for describing an example scenario in which an electronic device obtains a list, according to an embodiment of the disclosure.

FIG. 10 is a diagram for describing an example scenario in which an electronic device obtains a title corresponding to a list by inputting the list to a second AI model, according to an embodiment of the disclosure.

FIG. 11 is a diagram for describing an example scenario in which an electronic device obtains an image by inputting a title corresponding to a list to a third AI model, according to an embodiment of the disclosure.

FIG. 12 is a diagram for describing an example scenario in which an electronic device updates a list, according to an embodiment of the disclosure.

FIG. 13 is a diagram for describing an example scenario in which an electronic device provides a list, a title corresponding to the list, and an image, according to an embodiment of the disclosure.

FIG. 14 is a diagram for describing an example process of a system, according to an embodiment of the disclosure.

FIG. 15 is a diagram for describing an example process of a system, according to an embodiment of the disclosure.

FIG. 16 is a diagram for describing an example process of a system, according to an embodiment of the disclosure.

FIG. 17 is a block diagram for describing an example of a configuration of an electronic device according to an embodiment of the disclosure.

### DETAILED DISCLOSURE

Terms that are used in the specification will be briefly described, and the disclosure will be described in detail. Throughout the disclosure, the expression “at least one of a, b or c” indicates only a, only b, only c, both a and b, both a and c, both b and c, all of a, b, and c, or variations thereof.

Although the terms used in the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant, and the meaning of those terms will be described in detail in the corresponding part of the detailed description. Therefore, the terms used in the disclosure are not merely designations of the terms, but the terms are defined based on the meaning of the terms and content throughout the disclosure.

The singular forms “a,” “an,” and “the” may include the plural forms as well, unless the context clearly indicates otherwise. Unless otherwise defined, all terms including technical or scientific terms used herein may have the same meanings as commonly understood by one of ordinary skill in the art of the disclosure. While terms as “first,” “second,” etc., may be used in the specification so as to describe various elements, the elements must not be limited to the above terms. The above terms are used only to distinguish one element from another.

Also, in the disclosure, when a part “includes” or “comprises” an element, unless there is a particular description contrary thereto, the part can further include other elements, not excluding the other elements. Also, the terms such as “unit,” “module,” or the like used in the specification indicate a unit, which processes at least one function or operation, and the unit may be implemented by hardware or software, or by a combination of hardware and software.

Functions related to artificial intelligence (AI) according to the disclosure operate via a processor and memory. The processor may refer to one or more processors. The one or more processors may each correspond to a general-purpose processor such as a central processing unit (CPU), an application processor (AP), a digital signal processor (DSP), or the like, a graphics-dedicated processor such as a graphics processing unit (GPU), a vision processing unit (VPU) or the like, or an AI-dedicated processor such as a neural processing unit (NPU). The one or more processors may each control input data to be processed, according to predefined operating rules or an AI model stored in the memory. Alternatively, when each of the one or more processors is an AI-dedicated processor, the AI-dedicated processor may be designed in a hardware structure specialized for processing a particular AI model.

The predefined operating rules or the AI model may be generated via a training process. Here, being generated via a training process may mean that the predefined operation rules or the AI model set to perform desired characteristics (or purposes), is generated by training a basic AI model by using a learning algorithm that utilizes a large amount of training data. Such training may be performed by a device on which AI according to the disclosure is implemented or by a separate server and/or a system. Examples of the learning algorithm may include supervised learning, unsupervised learning, semi-supervised learning, or reinforcement learning, but the disclosure is not limited to the example above.

The AI model may include a plurality of neural network layers. Each of the plurality of neural network layers has a plurality of weight values, and performs a neural network operation through an operation between an operation result of a previous layer and the plurality of weight values. The plurality of weight values of the plurality of neural network layers may be optimized due to a training result of the AI model. For example, the plurality of weight values may be updated to reduce or minimize a loss value or a cost value obtained by the AI model during a training process Examples of the AI neural network may include a deep neural network (DNN), a convolutional neural network (CNN), a recurrent neural network (RNN), a restricted Boltzmann machine (RBM), a deep belief network (DBN), a bidirectional recurrent deep neural network (BRDNN), a Deep Q-Network, or the like, but the disclosure is not limited thereto.

All functions or operations described in the specification may be processed by one processor or a combination of processors. The one processor or the combination of processors may indicate processing circuitry for performing processing, and may include processing circuitry such as an application processor (AP), a communication processor (CP), graphical processing unit (GPU), a neural processing unit (NPU), a microprocessor unit (MPU), a system on chip (SoC), an integrated chip (IC), or the like.

Hereinafter, an embodiment of the disclosure will be described in detail with reference to the accompanying drawings to allow one of skill in the art to easily implement the embodiment. The disclosure may, however, be embodied in many different forms and should not be construed as being limited to an embodiment set forth herein. In the drawings, for a more clear description of the disclosure, parts or units that are not related to the disclosure are omitted, and throughout the specification, like reference numerals denote like elements.

Hereinafter, the disclosure will be described with reference to the accompanying drawings.

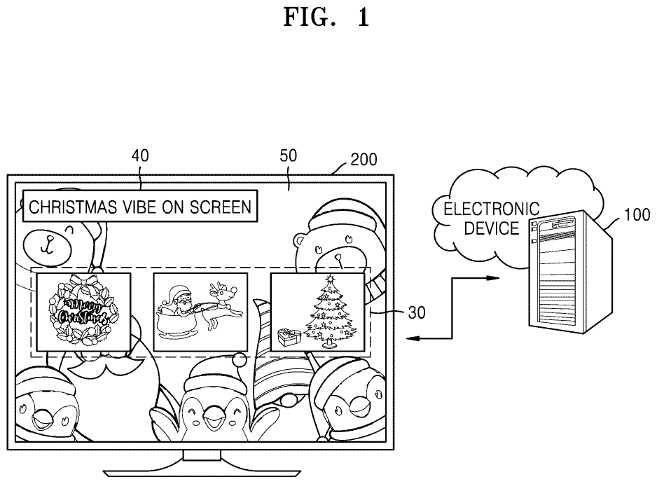

FIG. 1 is a schematic diagram for describing an operation in which an electronic device provides recommended content, according to an embodiment of the disclosure.

According to an embodiment of the disclosure, an electronic device 100 may provide recommended content, based on a user input. The recommended content may include at least one of a list, a title corresponding to the list, or an image related to the title corresponding to the list.

According to an embodiment of the disclosure, the electronic device 100 may provide a list 30. The list 30 may refer to a list in which a plurality of pieces of recommended content related to the user input are listed or a list in which information corresponding to the plurality of pieces of recommended content related to the user input is listed.

According to an embodiment of the disclosure, the electronic device 100 may obtain the plurality of pieces of recommended content related to the user input, by using a generative AI model. The electronic device 100 may generate the list 30 by using the plurality of pieces of recommended content. The electronic device 100 may provide the list 30 via a display device 200 or to the display device 200. In an embodiment, the electronic device 100 may control the display device 200 through control signals to display the list 30.

Also, according to an embodiment of the disclosure, the electronic device 100 may provide a title 40 corresponding to the list 30. The title 40 corresponding to the list 30 may include a title 40 associated with the list 30. The title 40 corresponding to the list 30 may refer to a word, a phrase, or a sentence which collectively correspond to the plurality of pieces of recommended content included in the list 30. For example, the title 40 corresponding to the list 30 may include a phrase, a theme message, description text, or a recommendation slogan which introduces recommended content included in the list 30.

According to an embodiment of the disclosure, the electronic device 100 may obtain the title 40 corresponding to the list 30 and being related to the list 30, by using the generative AI model. The electronic device 100 may provide title 40 corresponding to the list 30 via the display device 200 or to the display device 200. In an embodiment, the electronic device 100 may control the display device 200 through control signals to display the title 40.

Also, according to an embodiment of the disclosure, the electronic device 100 may provide an image 50. The image 50 may refer to an image that expresses the title 40 corresponding to the list 30. The image 50 may refer to an image that visually promotes the title 40 corresponding to the list 30. For example, the image 50 may refer to an image that helps a viewer visually associate the meaning or the characteristic of the title 40 corresponding to the list 30. Alternatively, the image 50 may refer to an image that complements the title 40 corresponding to the list 30. For example, the image 50 may refer to an image that helps a viewer understand the meaning or the characteristic of the title 40 corresponding to the list 30.

According to an embodiment of the disclosure, the electronic device 100 may obtain the image 50 related to the title 40 corresponding to the list 30, by using the generative AI model. The electronic device 100 may provide the image 50 via the display device 200 or to the display device 200. In an embodiment, the electronic device 100 may control the display device 200 through control signals to display the image 50. In an embodiment, the electronic device 100 may control the display device 200 through control signals to display the list 30, the title 40, and the image 50.

According to an embodiment of the disclosure, the electronic device 100 may obtain a user input. According to an embodiment of the disclosure, a ‘user’ may include a content curator that attempts to provide recommended content to a viewer, or a manager that produces recommended content.

In the disclosure, a ‘user input’ may indicate data input by a user of the electronic device 100 so as to obtain recommended content. The user input may indicate data including a particular topic, a theme, a genre, a character, a background, or the like. The user input may be obtained via a remote controller or a keyboard, which is an input unit of the electronic device 100. The user input may correspond to an input of various types (e.g., a speech input, a touch input, etc.), as well as an input via the remote controller or the keyboard. According to an embodiment of the disclosure, the electronic device 100 may convert a speech signal with respect to the speech input to text. Alternatively, the input unit of the electronic device 100 may transmit the speech signal indicating the speech input to the electronic device 100, and the electronic device 100 may convert the user input to text.

In the disclosure, ‘content’ may refer a subject matter such as information, a material, or the like which is provided by a medium or a platform. The content may have various formats including text, an image, a video, audio, or the like. For example, the content may include audiovisual content such as movies, dramas, and documentaries, audio content such as music, visual content such as webtoons and electronic-books (e-books), interactive content such as games, or the like, but the disclosure is not limited to the aforementioned examples. In the disclosure, ‘recommended content’ may indicate content that a user or viewer is likely to prefer or be interested in among various pieces of content. In the disclosure, ‘recommended content’ may indicate content that is recommended by an AI model.

According to the related art, a user manually recommended content, but, according to embodiments of the disclosure, the electronic device 100 may recommend content by using an AI model, and may provide at least one of a list, a title corresponding to the list, or an image. According to embodiments of the disclosure, the electronic device 100 may not only efficiently provide content related to a user input but also may provide related content by rapidly analyzing a huge database. The electronic device 100 may obtain, by using the AI model, not only a content list but also a related title and image.

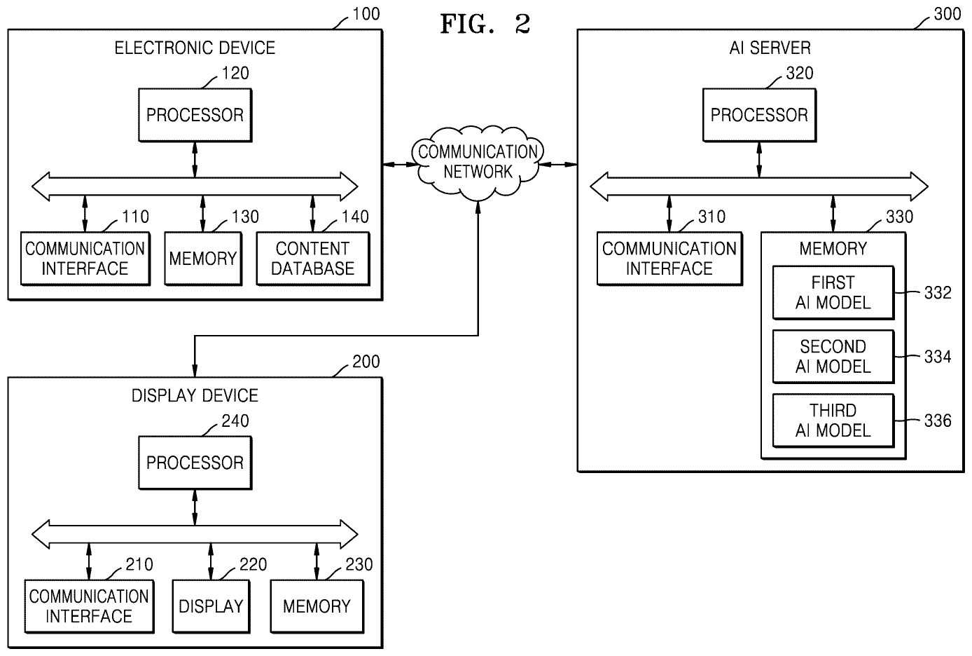

FIG. 2 is a diagram illustrating a system according to an embodiment of the disclosure.

According to an embodiment of the disclosure, the system may include the electronic device 100, the display device 200, and an AI server 300 which are connected via a communication network. Referring to FIG. 2, the electronic device 100 may be connected to the AI server 300 that operates an AI model. The electronic device 100 may transmit a request to the AI server 300 so as to use the AI model, and thus, may receive, from the AI server 300, result data obtained by using the AI model.

In the disclosure, an example of the AI model may include a neural network model. At least one operation among operations of the AI model of the disclosure may be carried out by performing computation via a neural network.

In the disclosure, a ‘model’ and a ‘network’ which are used in relation to AI may be interchangeable concepts. For example, an ‘AI model’ may be referred to as an ‘AI network’. The term ‘model’ may include various forms of an AI model which include a neural network model, and the AI model may include a neural network model that has a network-form structure.

According to an embodiment of the disclosure, the electronic device 100 may include a communication interface 110, at least one processor 120, memory 130, and a content database 140.

According to an embodiment of the disclosure, the electronic device 100 may refer to a device of various types which provide recommended content. For example, the electronic device 100 may be a server device that provides content, according to a request of the display device 200. The communication interface 110 may include various types of communication circuitry for performing communication with at least one external device. In this regard, the ‘communication’ may indicate an operation of transmitting and/or receiving data, a signal, a request, and/or a command.

The communication interface 110 may perform wired or wireless communication with at least one external device. An external device may include the display device 200 or the AI server 300.

For example, the communication interface 110 may include at least one of a communication module, communication circuitry, a communication device, an input/output port, or an input/output plug, which are arranged to perform wired or wireless communication with at least one external device.

The processor 120 may control all operations of the electronic device 100. The processor 120 may include processing circuitry. For example, the processor 120 may execute one or more instructions of a program stored in the memory 130 to control all operations in which the electronic device 100 provides recommended content. The processor 120 may refer to one or more processors.

The processor 120 may include, for example, at least one of a CPU, a microprocessor, a GPU, application specific integrated circuits (ASICs), DSPs, digital signal processing devices (DSPDs), programmable logic devices (PLDs), field programmable gate arrays (FPGAs), an AP, an NPU, or a dedicated AI processor designed with a hardware structure specialized for processing an AI model, but the disclosure is not limited thereto.

According to an embodiment of the disclosure, the processor 120 may refer to one or more processors. When the processor 120 corresponds to one or more processors, operations of the disclosure may be performed in a manner that the one or more processors individually or collectively execute instructions and/or the program stored in the memory 130. When a method according to an embodiment of the disclosure includes a plurality of operations, the plurality of operations may be performed by one processor 120 or may be performed by the processor 120 provided in plural.

According to an embodiment of the disclosure, the one or more processors may be implemented as a single-core processor or a multicore processor. When a method according to an embodiment of the disclosure includes a plurality of operations, the plurality of operations may be performed by one core or may be performed by a plurality of cores included in the one or more processors.

According to an embodiment of the disclosure, instructions included in the memory 130, when executed by the at least one processor 120 individually or collectively, may cause the electronic device 100 to obtain a list based on a plurality of pieces of recommended content obtained from a first AI model, based on a user input. The electronic device 100 may obtain the title corresponding to the list from a second AI model, based on the obtained list. The electronic device 100 may obtain, from a third AI model, an image based on the title corresponding to the list. The electronic device 100 may provide the list, the title corresponding to the list, and the image.

According to an embodiment of the disclosure, the first AI model may include a first generative AI model that generates text. The electronic device 100 may input the user input to the first generative AI model, and thus, may obtain information corresponding to each recommended content among the plurality of pieces of recommended content related to the user input.

According to an embodiment of the disclosure, the information corresponding to each recommended content may include a title of each recommended content. The information corresponding to each recommended content may further include at least one of the platform corresponding to provision of the content, the release date of the content, the producer of the content, the runtime of the content, the genre of the content, or performer information of the content.

According to an embodiment of the disclosure, based on the user input and target viewer information, the electronic device 100 may obtain, by using the first generative AI model, information related each recommended content among the plurality of pieces of recommended content which are related to the user input and for which a target viewer is considered.

According to an embodiment of the disclosure, the target viewer information may include at least one of a gender of the target viewer, a platform used by the target viewer, or a preferred genre of the target viewer.

According to an embodiment of the disclosure, when each recommended content is included in a content database, the electronic device 100 may add each recommended content to a list.

According to an embodiment of the disclosure, the second AI model may include a second generative AI model that generates text. The electronic device 100 may obtain, based on the list, by using the second generative AI model, the title corresponding to the list that corresponds to the plurality of pieces of recommended content included in the list.

According to an embodiment of the disclosure, the third AI model may include a third generative AI model that generates an image. The electronic device 100 may obtain, based on the obtained title, by using the third generative AI model, the image related to the title corresponding to the list.

According to an embodiment of the disclosure, when receiving data from the display device 200, the electronic device 100 may transmit, to the display device 200, the list, the title corresponding to the list, and the image, based on the received data.

The memory 130 may store various information, data, instructions, programs, etc. which are required for an operation of the electronic device 100. The memory 130 may include at least one of a volatile memory or a non-volatile memory or a combination thereof. The memory 130 may include at least one type of storage medium from among flash memory, a hard disk, a multimedia card micro, a memory card (e.g., a secure digital (SD) or extreme digital (XD) memory card), random access memory (RAM), static random access memory (SRAM), read-only memory (ROM), electrically erasable programmable read-only memory (EEPROM), programmable read-only memory (PROM), magnetic memory, a magnetic disk, and an optical disc. Also, the memory 130 may correspond to a web storage or a cloud server which performs a storage function on the Internet.

The content database 140 may include information corresponding to content that may be provided by the display device 200. The content database 140 may indicate a database that stores information corresponding to content. The content that may be provided by the display device 200 may indicate various types of content which are provided by contents providers. A contents provider may indicate a terrestrial broadcaster, a cable broadcaster, a satellite broadcaster which provides various types of content to a viewer, or an Internet Protocol Television (IPTV) service provider or an Over the Top (OTT) service provider, or a server operator that provides various types of content.

The content database 140 may store information corresponding to content. For example, the information corresponding to content may include detailed information such as a title of content, a release date of the content, a producer of the content, a runtime of the content, a genre of the content, performers in the content, a platform corresponding to provision of the content, a viewer age rating of the content, or the like.

The content database 140 may include at least one of a volatile memory or a non-volatile memory or a combination thereof. The content database 140 may include at least one type of storage medium from among flash memory, a hard disk, a multimedia card micro, a memory card (e.g., an SD or XD memory card), RAM, SRAM, ROM, EEPROM, PROM, magnetic memory, a magnetic disk, and an optical disc. Also, the content database 140 may correspond to a web storage or a cloud server which performs a storage function on the Internet.

The content database 140 may be updated via connection to an external server (not shown). For example, when new content is provided from contents providers to the display device 200, the electronic device 100 may add information corresponding to the new content to the content database 140. For example, when provision of content from contents providers to the display device 200 is discontinued, the electronic device 100 may delete information corresponding to the discontinued content from the content database 140.

According to an embodiment of the disclosure, the display device 200 may include a communication interface 210, a display 220, memory 230, and at least one processor 240. The display device 200 may be embodied with more elements than the shown elements, and is not limited to the aforementioned example.

The display device 200 may be implemented as various types and forms of an electronic device capable of connecting to a display by wire or wirelessly. For example, the display device 200 may include devices such as a set-top box, a desktop personal computer (PC), a server, etc., which is connectable to a display by wire or wirelessly and is capable of displaying an image on the display, but the disclosure is not limited thereto.

As another example, the display device 200 may be implemented as various types and forms of an electronic device including a display. The display device 200 may include devices such as a television (TV), a smart TV, a smartphone, a tablet PC, a laptop PC, a glasses-type display, a head-mounted display (HMD), etc. which are capable of displaying an image on a display, but the disclosure is not limited thereto.

The communication interface 210 may include various types of communication circuitry configured to perform communication with the electronic device 100 or the AI server 300. The communication interface 210 may perform wired or wireless communication with the electronic device 100.

For example, the communication interface 210 may include a short-range communication module capable of receiving a control command from a remote controller, e.g., an external device, which is located within a short range, an infrared (IR) communication module, or the like. In this case, the communication interface 210 may receive a control signal from the remote controller.

As another example, the communication interface 210 may include at least one communication module configured to perform communication that complies with wireless communication rules including Bluetooth, Wi-Fi, Bluetooth low energy (BLE), near field communication (NFC)/radio frequency identification (RFID), Wi-Fi direct, ultra-wideband (UWB), ZigBee, or the like. Alternatively, the communication interface 210 may further include a communication module configured to perform communication with a server configured to support long-range communication, according to long-range communication rules. For example, the communication interface 210 may include a communication module configured to perform communication via a network for Internet communication. Also, the communication interface 210 may include a communication module configured to perform communication via a communication network that complies with communication rules including 3^{rd}-generation (3G), 4^{th}-generation (4G), 5^{th-}generation (5G) and/or 6^{th}-generation (6G).

As another example, the communication interface 210 may include at least one port for connection to an external device via a wired cable so as to communicate with the external device by wire. For example, the communication interface 210 may include at least one of a high-definition multimedia interface (HDMI) port, a component jack, a PC port, or a universal serial bus (USB) port. Accordingly, the communication interface 210 may perform communication with the external device connected by wire via at least one port. Here, the port may indicate a physical device configuration that allows connection or insertion of a cable, a communication line, a plug, or the like.

As described above, the communication interface 210 may include at least one support element for supporting communication between the display device 200 and an external device. Here, the support element may include a communication module, communication circuitry, a communication device, a port (for input/output of data), a cable for (for input/output of data), a plug (for input/output of data), or the like, which are described above. For example, an example of the at least one support element included in the communication interface 210 may correspond to an Ethernet communication module, a Wi-Fi communication module, a Bluetooth communication module, an IR communication module, a USB port tuner (or, a broadcast receiver), an HDMI port, a display port (DP), a digital visual interface (DVI) port, or the like.

The display 220 may output an image or data which is processed by the electronic device 100. For example, the display 220 may display recommended content provided via the communication interface 210 from the electronic device 100. While the display 220 is shown as being included in the display device 200, the disclosure is not limited thereto. The display 220 may be external to the display device 200 and be connected to the display device 200 via wired/wireless communication, and the display device 200 may transmit display-target content to the display 220 by using wired/wireless communication.

The memory 230 may store a program for processing and control by the processor 240, and may store data input to the display device 200 or output from the display device 200.

The memory 230 may include at least one type of storage medium from among flash memory, a hard disk, a multimedia card micro, a memory card (e.g., an SD or XD memory card), RAM, SRAM, ROM, EEPROM, PROM, magnetic memory, a magnetic disk, and an optical disc.

The processor 240 includes various types of processing circuitry for controlling all operations of the display device 200. For example, the processor 240 may execute one or more instructions stored in the memory 230 to perform a function of the display device 200 which is described in the disclosure.

According to an embodiment of the disclosure, the processor 240 may store one or more instructions in internal memory provided therein, and may execute the one or more instructions stored in the internal memory to control aforementioned operations to be performed. That is, the processor 240 may execute at least one instruction or a program stored in the memory 230 or the internal memory that is provided in the processor 240 to perform a defined (e.g., pre-defined) operation.

According to an embodiment of the disclosure, the processor 240 may execute the at least one instruction stored in the memory 230 to receive, from a user, an access request with respect to the electronic device 100. The processor 240 may execute the at least one instruction stored in the memory 230 to request the electronic device 100 for items to be used in a user interface that allows content provided by the electronic device 100 to be displayed and selected, according to the access request with respect to the electronic device 100. The processor 240 may execute the at least one instruction stored in the memory 230 to receive at least one of a list, a title corresponding to the list, or an image from the electronic device 100.

According to an embodiment of the disclosure, the processor 240 may execute the at least one instruction stored in the memory 230 to generate a user interface, based on the list, the title corresponding to the list, and the image. The processor 240 may execute the at least one instruction stored in the memory 230 to provide the display 220 with the user interface generated based on the list, the title corresponding to the list, and the image.

According to an embodiment of the disclosure, the AI server 300 may include a communication interface 310, at least one processor 320, and memory 330. The AI server 300 may be embodied with more elements than the shown elements, and is not limited to the aforementioned example. When receiving a request from the electronic device 100, the AI server 300 may obtain data by using one or more AI models, and may transmit the obtained data to the electronic device 100.

The communication interface 310 may include various types of communication circuitry configured to perform communication with the electronic device 100 or the display device 200. The communication interface 310 may perform wired or wireless communication with the electronic device 100.

The processor 320 includes various types of processing circuitry for controlling all operations of the AI server 300. For example, the processor 320 may execute one or more instructions stored in the memory 330 to perform a function of the AI server 300 which is described in the disclosure.

According to an embodiment of the disclosure, the processor 320 may store one or more instructions in internal memory provided therein, and may execute the one or more instructions stored in the internal memory to control aforementioned operations to be performed. That is, the processor 320 may execute at least one instruction or a program stored in the memory 330 or the internal memory that is provided in the processor 320 to perform a defined (e.g., pre-defined) operation.

According to an embodiment of the disclosure, the processor 320 may execute the at least one instruction stored in the memory 330 to, when receiving a user input from the electronic device 100, recommend a plurality of pieces of content corresponding to the user input by using a first AI model 332. The processor 320 may execute the at least one instruction stored in the memory 330 to transmit the recommend plurality of pieces of content to the electronic device 100.

According to an embodiment of the disclosure, the processor 320 may execute the at least one instruction stored in the memory 330 to, when receiving target viewer information from the electronic device 100, recommend a plurality of pieces of content corresponding to the user input and the target viewer information by using the first AI model 332. The processor 320 may execute the at least one instruction stored in the memory 330 to transmit the plurality of pieces of content corresponding to the user input and the target viewer information to the electronic device 100.

According to an embodiment of the disclosure, the processor 320 may execute the at least one instruction stored in the memory 330 to recommend a plurality of pieces of content. The processor 320 may execute the at least one instruction stored in the memory 330 to generate information corresponding to the recommended plurality of pieces of content, and may transmit the generated information corresponding to content to the electronic device 100.

According to an embodiment of the disclosure, the processor 320 may execute the at least one instruction stored in the memory 330 to, when receiving a list from the electronic device 100, generate a title corresponding to the list by using a second AI model 334. The processor 320 may execute the at least one instruction stored in the memory 330 to transmit the title corresponding to the list to the electronic device 100.

According to an embodiment of the disclosure, the processor 320 may execute the at least one instruction stored in the memory 330 to generate an image related to the title corresponding to the list. The processor 320 may execute the at least one instruction stored in the memory 330 to transmit the image to the electronic device 100.

The memory 330 may store a program for processing and control by the processor 320, and may store data input to the AI server 300 or output from the AI server 300.

The memory 330 may include at least one type of storage medium from among flash memory, a hard disk, a multimedia card micro, a memory card (e.g., an SD or XD memory card), RAM, SRAM, ROM, EEPROM, PROM, magnetic memory, a magnetic disk, and an optical disc.

The memory 330 may store one or more instructions and one or more programs which allow the AI server 300 to recommend content. According to an embodiment of the disclosure, the memory 330 may store an AI model that is operated by the AI server 300. For example, the memory 330 may store the first AI model 332, the second AI model 334, and a third AI model 336.

According to an embodiment of the disclosure, the first AI model 332 may receive a user input, and thus, may output a plurality of pieces of content corresponding to the user input. The first AI model 332 may include a generative AI model specialized for generating text.

According to an embodiment of the disclosure, the second AI model 334 may receive an input of a list, and thus, may output a title corresponding to the list. The second AI model 334 may include a generative AI model specialized for generating text.

According to an embodiment of the disclosure, the third AI model 336 may receive an input of a title corresponding to the list, and thus, may output an image related to the title corresponding to the list. The third AI model 336 may include a generative AI model specialized for generating an image.

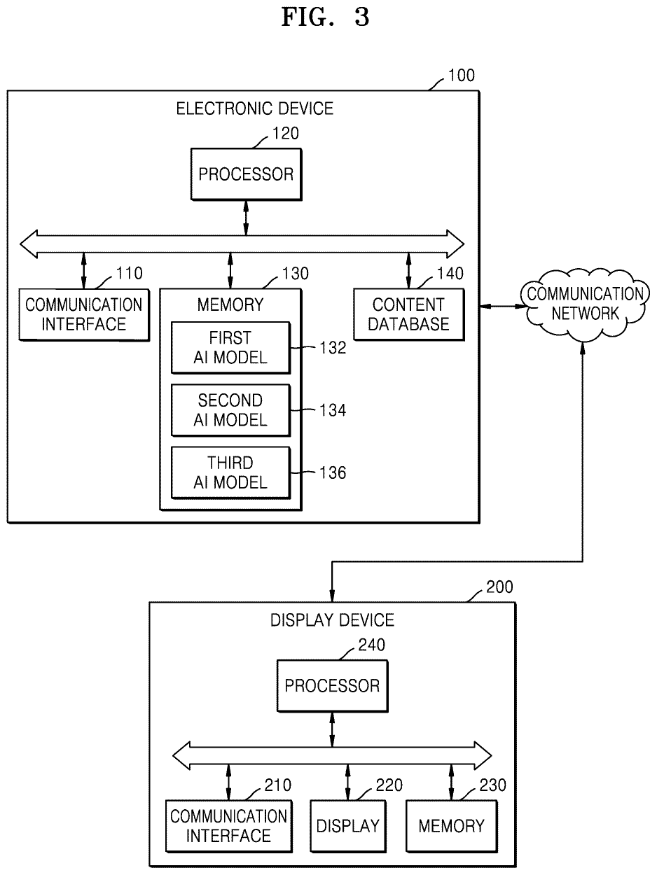

FIG. 3 is a diagram illustrating a system according to an embodiment of the disclosure.

According to an embodiment of the disclosure, the system may include the electronic device 100 and the display device 200 connected via a communication network. Referring to FIG. 3, the electronic device 100 may internally operate an AI model, without the need for connection to an external AI server. For example, the electronic device 100 may operate the AI model that is executable by using a computing resource retained by the electronic device 100.

According to an embodiment of the disclosure, the electronic device 100 may include the communication interface 110, the at least one processor 120, the memory 130, and the content database 140.

The electronic device 100, the communication interface 110, the at least one processor 120, the memory 130, and the content database 140 which are shown in FIG. 3 may respectively correspond to the electronic device 100, the communication interface 110, the at least one processor 120, the memory 130, and the content database 140 which are shown in FIG. 2.

Referring to FIG. 3, the memory 130 may store one or more instructions and one or more programs which cause the electronic device 100 to provide recommended content. According to an embodiment of the disclosure, the memory 130 may store an AI model operated by the electronic device 100. For example, the memory 130 may store a first AI model 132, a second AI model 134, and a third AI model 136. The AI model stored in the memory 130 may be relatively a lightweight AI model, compared to an AI model operable by an external server, but the disclosure is not limited thereto.

In an embodiment of the disclosure, the processor 120 may store one or more instructions in internal memory provided therein, and may execute the one or more instructions stored in the internal memory to control operations which are described above or below to be performed. That is, the processor 120 may execute at least one instruction or a program stored in the memory 130 or the internal memory that is provided in the processor 120 to perform a defined (e.g., pre-defined) operation.

According to an embodiment of the disclosure, the processor 120 may execute the one or more instructions stored in the memory 130 to recommend, when obtaining a user input, a plurality of pieces of content corresponding to the user input by using the first AI model 132.

According to an embodiment of the disclosure, the processor 120 may execute the one or more instructions stored in the memory 130 to recommend, when obtaining target viewer information, a plurality of pieces of content corresponding to the user input and the target viewer information by using the first AI model 132.

According to an embodiment of the disclosure, the processor 120 may execute the one or more instructions stored in the memory 130 to recommend a plurality of pieces of content. The processor 120 may execute the one or more instructions stored in the memory 130 to generate information corresponding to the recommend plurality of pieces of content by using the first AI model 132.

According to an embodiment of the disclosure, the processor 120 may execute the one or more instructions stored in the memory 130 to generate, when obtaining a list from the electronic device 100, a title corresponding to the list by using the second AI model 134.

According to an embodiment of the disclosure, the processor 120 may execute the one or more instructions stored in the memory 130 to generate, when obtaining an title corresponding to the list, an image related to the title corresponding to the list.

According to an embodiment of the disclosure, the display device 200 may include the communication interface 210, the display 220, the memory 230, and the at least one processor 240.

The display device 200, the communication interface 210, the display 220, the memory 230, and the at least one processor 240 which are shown in FIG. 3 may respectively correspond to the display device 200, the communication interface 210, the display 220, the memory 230, and the at least one processor 240 which are shown in FIG. 2.

Hereinafter, in the accompanying drawings, it is described that, as shown in FIG. 2, an operation of the electronic device 100 is performed via connection to the AI server 300 outside the electronic device 100. However, as shown in FIG. 3, without the need for connection to the AI server 300, the electronic device 100 may operate by using an AI model included in the electronic device 100.

In the above, referring to FIG. 2, it is described that an AI model is included in the AI server 300 outside the electronic device 100, and the AI server 300 obtains data by using the AI model and transmits the data to the electronic device 100. Referring to FIG. 3, it is described that an AI model is included in the electronic device 100, and the electronic device 100 may perform an operation using the AI model included in the electronic device 100. However, the disclosure is not limited thereto, and some AI models among a plurality of AI models may be included in the AI server 300, and some AI models may be included in the electronic device 100. For example, some of a first AI model to a third AI model may be operated by the external AI server 300, and others may be operated by the electronic device 100.

Also, according to an embodiment of the disclosure, the first AI model, the second AI model, and the third AI model may be implemented as one AI model. For example, one AI model may perform operations of the first AI model, the second AI model, and the third AI model.

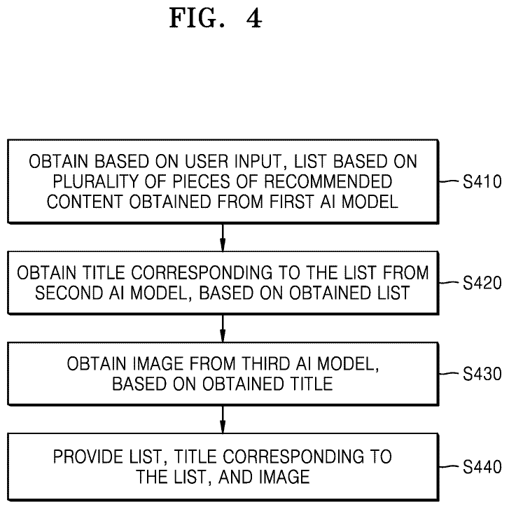

FIG. 4 is a flowchart for describing an example of an operation in which an electronic device provides recommended content, according to an embodiment of the disclosure.

Referring to FIG. 4, all operations of the electronic device 100 of the disclosure will now be described. Also, with reference to drawings below, specific details of an operation of the electronic device 100 will now be described.

In operation S410, the electronic device 100 may obtain, based on a user input, a list based on a plurality of pieces of recommended content obtained from a first AI model.

According to an embodiment of the disclosure, the electronic device 100 may receive the user input, and may obtain the plurality of pieces of recommended content from the first AI model, based on the user input. According to an embodiment of the disclosure, the electronic device 100 may obtain the user input. The electronic device 100 may generate a first input prompt for inputting the user input to the first AI model. The electronic device 100 may input the first input prompt including the user input to the first AI model. The first AI model may recommend the plurality of pieces of content related to the user input. The first AI model may generate information for each recommended content. The electronic device 100 may obtain, from the first AI model, information corresponding to recommended content.

According to an embodiment of the disclosure, the electronic device 100 may obtain target viewer information. A target viewer may indicate a viewer group attempting to receive at least one of recommended content, a list, a title corresponding to the list, or an image. The target viewer information may indicate data collected for the target viewer by the electronic device 100 to provide recommended content. For example, the target viewer information may include information such as an age of the target viewer, a gender of the target viewer, a platform used by the target viewer, an occupation of the target viewer, a genre preferred by the target viewer, topics preferred by the target viewer, a viewing history of the target viewer, or the like. The electronic device 100 may receive the target viewer information from the display device 200 or an external server.

According to an embodiment of the disclosure, the electronic device 100 may obtain the plurality of pieces of recommended content from the first AI model, based on the user input and the target viewer information. The electronic device 100 may generate a first input prompt for inputting the user input and the target viewer information to the first AI model. The electronic device 100 may input the first input prompt including the user input and the target viewer information to the first AI model. The first AI model may recommend the plurality of pieces of content related to the user input and the target viewer information. The first AI model may generate information for each recommended content. The electronic device 100 may obtain, from the first AI model, information corresponding to recommended content. In this manner, by adding the target viewer information as an input to the first AI model, recommended content more appropriate for the target viewer or the information corresponding to recommended content may be obtained.

According to an embodiment of the disclosure, the electronic device 100 may obtain a list, based on the plurality of pieces of recommended content obtained from the first AI model. The electronic device 100 may obtain, from the first AI model, a plurality of pieces of information respectively corresponding to the plurality of pieces of recommended content. The electronic device 100 may generate the list 30, based on the plurality of pieces of recommended content. The electronic device 100 may use the content database 140 so as to generate the list 30.

According to an embodiment of the disclosure, the electronic device 100 may provide only content existing in the content database 140. However, the plurality of pieces of recommended content obtained by using the first AI model may include content that is not provided by the electronic device 100. Therefore, in order to exclude the content not provided by the electronic device 100 from the plurality of pieces of recommended content, the electronic device 100 may compare content of the content database 140 with the plurality of pieces of recommended content obtained by using the first AI model. The electronic device 100 may compare each of the plurality of pieces of recommended content obtained from the first AI model with the content included in the content database 140. For example, the electronic device 100 may compare information of each recommended content with information of the content included in the content database 140.

According to an embodiment of the disclosure, when the obtained recommended content is included in the content database 140, the electronic device 100 may add the recommended content to the list 30. Each recommended content added to the list 30 is content existing in the content database 140. The electronic device 100 may add, to the list 30, information corresponding to recommended content. The list 30 may include only content that may be provided by the electronic device 100 or only information corresponding to the content that may be provided by the electronic device 100.

In operation S420, the electronic device 100 may obtain a title corresponding to the list from a second AI model, based on the obtained list.

According to an embodiment of the disclosure, the electronic device 100 may obtain the title 40 corresponding to the list 30, by using the second AI model. The electronic device 100 may generate a second input prompt for inputting the list 30 to the second AI model. The electronic device 100 may input the second input prompt including the list 30 to the second AI model. The second AI model may generate the title 40 corresponding to the list 30 and being related to the list 30. The electronic device 100 may obtain the title 40 corresponding to the list 30 from the second AI model.

In operation S430, the electronic device 100 may obtain an image from a third AI model, based on the title corresponding to the list.

According to an embodiment of the disclosure, the electronic device 100 may obtain the image 50 by using the third AI model. The electronic device 100 may generate a third input prompt for inputting title 40 corresponding to the list 30 to the third AI model. The electronic device 100 may input the third input prompt including title 40 corresponding to the list 30 to the third AI model. The third AI model may generate the image 50 related to the title 40 corresponding to the list 30. The electronic device 100 may obtain the image 50 from the third AI model.

In operation S440, the electronic device 100 may provide the list, the title corresponding to the list, and the image.

According to an embodiment of the disclosure, the electronic device 100 may receive, from the display device 200, a request for an item to be used for a home user interface of the display device 200. The list 30, title 40 corresponding to the list 30, and the image 50 may be used as the item for the home user interface of the display device 200. The electronic device 100 may transmit at least one of the list 30, title 40 corresponding to the list 30, or the image 50 to the display device 200.

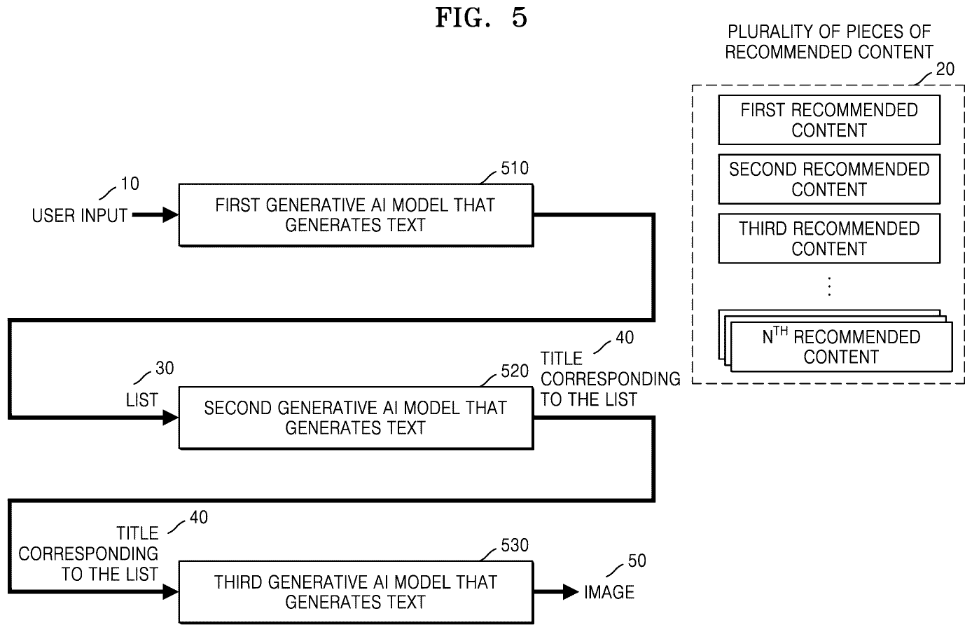

FIG. 5 is a diagram for describing an example of an operation in which an electronic device uses a generative AI model, according to an embodiment of the disclosure.

According to an embodiment of the disclosure, a first AI model may include a first generative AI model 510. The electronic device 100 may input a user input 10 to the first generative AI model 510. The electronic device 100 may obtain a plurality of pieces of recommended content 20 by using the first generative AI model 510.

According to an embodiment of the disclosure, the first generative AI model 510 may be an AI model specialized for generating text. For example, the first generative AI model 510 may be a language model (LM). In detail, the first generative AI model 510 may be a large language model (LLM). Compared to the LM, the LLM has been trained by using a large scale dataset and may perform a more complicated language processing task than the LM. The LLM requires a high performance computing resource, and thus, may be operated by a separate high performance computer system (e.g., the AI server 300). However, it is not limited that the LLM is operated by the separate high performance computer system, and the electronic device 100 may operate the LLM.

According to an embodiment of the disclosure, the first generative AI model 510 may be an AI model specialized for generating not only text but also specialized for generating an image. For example, the first generative AI model 510 may be a multi-modal AI model. The multi-modal AI model may be an AI model capable of simultaneously processing various types of data. For example, the multi-modal AI model may be an AI model capable of concurrently processing text data and image data.

According to an embodiment of the disclosure, the second AI model may include a second generative AI model 520. The electronic device 100 may input the list 30 to the second generative AI model 520. The list 30 may have been generated based on the plurality of pieces of recommended content 20. The electronic device 100 may obtain the title 40 corresponding to the list 30 by using the second generative AI model 520.

According to an embodiment of the disclosure, the second generative AI model 520 may be an AI model specialized for generating text. For example, the second generative AI model 520 may be an LM. In detail, the second generative AI model 520 may be an LLM.

According to an embodiment of the disclosure, the second generative AI model 520 may be an AI model specialized for generating an image and text. For example, the second generative AI model 520 may be a multi-modal AI model.

According to an embodiment of the disclosure, a third AI model may include a third generative AI model 530. The electronic device 100 may input the title 40 corresponding to the list 30 to the third generative AI model 530. The electronic device 100 may obtain the image 50 by using the third generative AI model 530.

According to an embodiment of the disclosure, the third generative AI model 530 may be an AI model specialized for generating an image. The third generative AI model 530 may be an AI model configured to generate an image by receiving an input of text. For example, the third generative AI model 530 may be a contrastive language-image pre-training (CLIP) model or a diffusion model.

According to an embodiment of the disclosure, the third generative AI model 530 may be an AI model specialized for generating an image and text. For example, the third generative AI model 530 may be a multi-modal AI model.

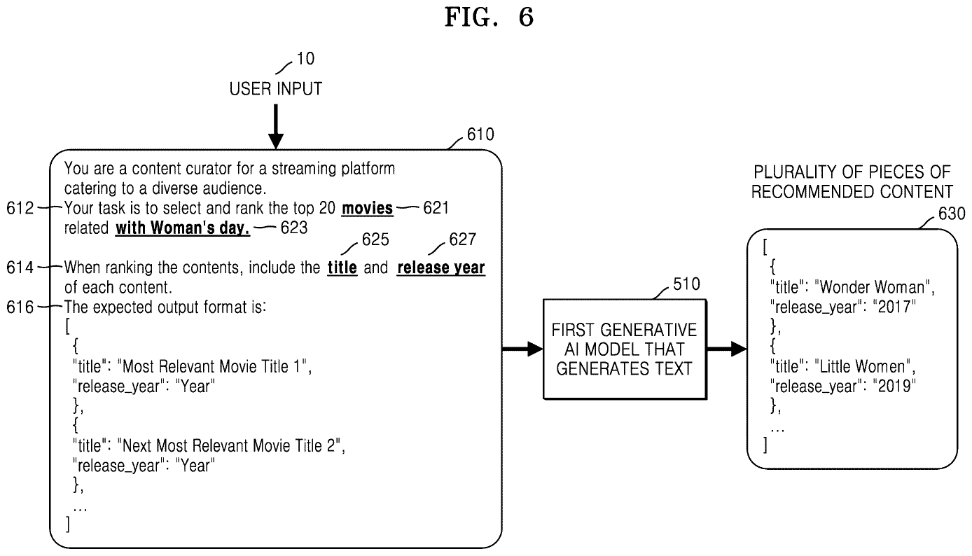

FIG. 6 is a diagram for describing an example of an operation in which an electronic device obtains a plurality of pieces of recommended content by inputting a user input to a first AI model, according to an embodiment of the disclosure.

According to an embodiment of the disclosure, the electronic device 100 may transmit the user input 10 to the first generative AI model 510. The electronic device 100 may generate a first input prompt 610 for inputting the user input 10 to the first generative AI model 510.

According to an embodiment of the disclosure, the first input prompt 610 may include a command, an instruction, and an input which are based on text and are to be input to the first generative AI model 510. For example, the command may be a request for allowing a generative AI model to perform a task. The instruction may be a task method or a task process that the generative AI model has to perform. The input may be data or information that the generative AI model has to process.

According to an embodiment of the disclosure, the electronic device 100 may generate the first input prompt 610 in a rule-based manner. For example, the electronic device 100 may generate the first input prompt 610 for requesting recommendation of a plurality of pieces of content by inserting the user input 10 to a placeholder of a first prompt template. According to an embodiment of the disclosure, the first prompt template may be stored in the memory 130 of the electronic device 100. Alternatively, the electronic device 100 may receive the first prompt template from an external server.

According to an embodiment of the disclosure, the first prompt template may predefine and provide at least one of a command, an instruction, or an input with respect to a task to be performed by the first generative AI model 510. The placeholder may correspond to a predefined position to which the user input 10 is inserted in the first prompt template. According to an embodiment of the disclosure, a placeholder to which the user input 10 is mapped may be preset for each attribute of the user input 10.

For example, the first prompt template may include a command 612. The command 612 may be a request for allowing the first generative AI model 510 to perform a ‘content recommendation’ task. The command 612 may include a placeholder to which a type 621 (e.g., a movie, a drama, etc.) of content is to be inserted. Also, the command 612 may include a placeholder to which a theme 623 of content is to be inserted.

Also, for example, the first prompt template may include an indication 614. The indication 614 may include information corresponding to content that has to be included when the first generative AI model 510 performs the ‘content recommendation’ task. The indication 614 may include placeholders 625 and 627 to which detailed information is to be inserted. For example, the indication 614 may include the title 625 of recommended content. Also, the indication 614 may include a release year 627 of the recommended content.

Also, for example, the first prompt template may include an indication 616. The indication 616 may include information about a format of outputting a task performance result from the first generative AI model 510.

According to an embodiment of the disclosure, the first generative AI model 510 may recommend a plurality of pieces of content, based on the first input prompt 610. For example, the first generative AI model 510 may perform a content recommendation task according to a command or an indication of the first input prompt 610.

According to an embodiment of the disclosure, the first generative AI model 510 may perform a content recommendation task. In detail, the first generative AI model 510 may generate information about each recommended content. For example, the first generative AI model 510 may generate a title of recommended content. Also, for example, the first generative AI model 510 may generate at least one of a platform corresponding to provision of the recommended content, the release date of the recommended content, the producer of the recommended content, the runtime of the recommended content, the genre of the recommended content, or performer information of the recommended content.

According to an embodiment of the disclosure, the electronic device 100 may obtain a plurality of pieces of recommended content 630 output by the first generative AI model 510. The electronic device 100 may obtain information about each of the plurality of pieces of recommended content 630 which is generated by the first generative AI model 510. For example, the electronic device 100 may obtain the title of content and the release year of the content recommended by the first generative AI model 510.

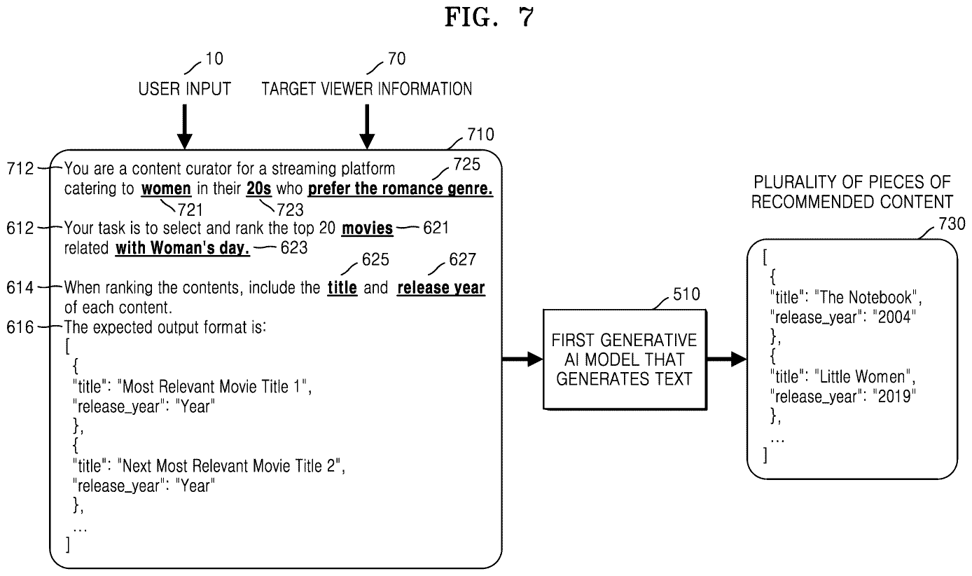

FIG. 7 is a diagram for describing an example of an operation in which an electronic device obtains a plurality of pieces of recommended content by inputting a user input and target viewer information to a first AI model, according to an embodiment of the disclosure.

According to an embodiment of the disclosure, the electronic device 100 may input the user input 10 and target viewer information 70 to the first generative AI model 510. The electronic device 100 may generate a first input prompt 710 for inputting the user input 10 and the target viewer information 70 to the first generative AI model 510. According to an embodiment of the disclosure, the first input prompt 710 may further include an indication 712 including the target viewer information 70, compared to the first input prompt 610.

According to an embodiment of the disclosure, the electronic device 100 may generate the first input prompt 710 in a rule-based manner. For example, the electronic device 100 may generate the first input prompt 710 for requesting recommendation of a plurality of pieces of content by inserting the user input 10 and the target viewer information 70 to the placeholder of the first prompt template.

For example, the first prompt template may include an indication 712. The indication 712 may include the target viewer information 70 that the first generative AI model 510 has to consider when performing a ‘content recommendation’ task. For example, the indication 712 may include a placeholder 721 to which a gender of a target viewer is to be inserted. Also, the indication 712 may include a placeholder 723 to which an age group of the target viewer is to be inserted. In addition, for example, the indication 712 may include a placeholder 725 to which a preferred genre of the target viewer is to be inserted.

According to an embodiment of the disclosure, the first input prompt 710 may be generated in a similar manner to the first input prompt 610. Descriptions related to operations of generating the first input prompt 610 are already provided with reference to descriptions of FIG. 6, and thus, repeated descriptions are omitted here.

According to an embodiment of the disclosure, the first generative AI model 510 may recommend a plurality of pieces of content, based on the first input prompt 710. For example, the first generative AI model 510 may perform a content recommend task, according to a command or an indication of the first input prompt 710.

According to an embodiment of the disclosure, the first generative AI model 510 may perform the content recommend task. According to an embodiment of the disclosure, as the first input prompt 710 including the user input 10 and the target viewer information 70 are input to the first generative AI model 510, the first generative AI model 510 may recommend a plurality of pieces of content, in consideration of the target viewer. For example, a plurality of pieces of recommended content 730 are an output to which the target viewer information 70 is considered, and thus, may be different from a plurality of pieces of recommended content 720.

According to an embodiment of the disclosure, the first generative AI model 510 may perform a content recommendation task. Descriptions related to operations in which the first generative AI model 510 performs a content recommendation task are already provided with reference to descriptions of FIG. 6, and thus, repeated descriptions are omitted here.

Also, according to an embodiment of the disclosure, the electronic device 100 may obtain a plurality of pieces of information respectively for the plurality of pieces of recommended content 730, in a similar scheme of an operation of obtaining information of each of the plurality of pieces of recommended content 630. Descriptions related to operations of obtaining information of each of the plurality of pieces of recommended content 630 are already provided with reference to descriptions of FIG. 6, and thus, repeated descriptions are omitted here.

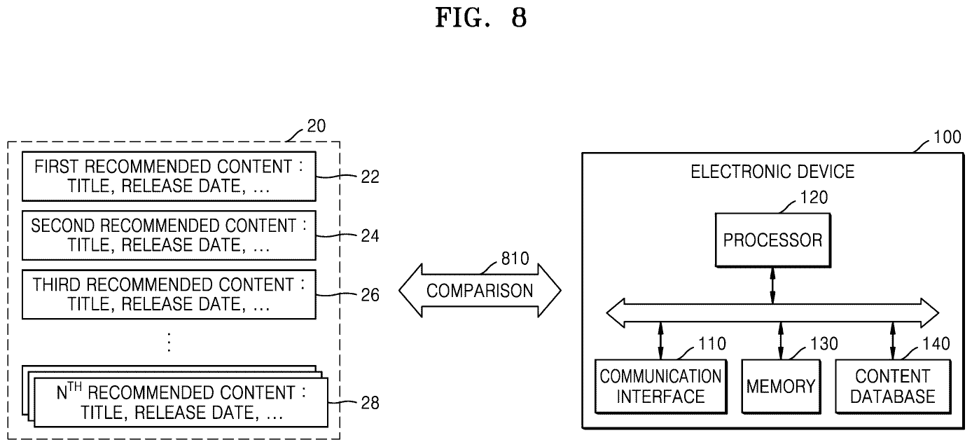

FIG. 8 is a diagram for describing an example of an operation in which an electronic device compares recommended content with a content database, according to an embodiment of the disclosure.

According to an embodiment of the disclosure, the electronic device 100 may generate the list 30, based on the plurality of pieces of recommended content 20. The electronic device 100 may obtain the plurality of pieces of recommended content 20 from a first AI model. The electronic device 100 may compare the plurality of pieces of recommended content 20 with the content database 140 (810), and thus, may generate the list 30.

According to an embodiment of the disclosure, the electronic device 100 may compare each recommended content included in the plurality of pieces of recommended content 20 with the content database 140 (810). The electronic device 100 may compare information of each recommended content with information about each content included in the content database 140. The electronic device 100 may compare detailed information of recommended content with detailed information of content included in the. In detail, the electronic device 100 may compare information of the content database 140 which has the same attribute with information of recommended content.

For example, the electronic device 100 may identify whether a title of recommended content matches a title of content included in the content database 140. The electronic device 100 may identify whether a release date of the recommended content matches a release date of the content included in the content database 140. The electronic device 100 may identify whether a genre of the recommended content matches a genre of the content included in the content database 140.

According to an embodiment of the disclosure, the electronic device 100 may identify whether each recommended content is stored in the content database 140. For example, the electronic device 100 may identify whether first recommended content 22 is included in the content database 140.

According to an embodiment of the disclosure, the electronic device 100 may identify whether information about the first recommended content 22 matches information corresponding to content included in the content database 140. For example, the electronic device 100 may compare a title of the first recommended content 22 with a title of the content included in the content database 140. Also, for example, the electronic device 100 may compare a release date of the first recommended content 22 with a release date of the content included in the content database 140.

According to an embodiment of the disclosure, the electronic device 100 may identify whether first recommended content 22 to Nth recommended content 28 are included in the content database 140. With reference to FIG. 8, an example of comparing a title or release date of recommended content with the content database 140 is described, but it is not limited to comparison of detailed information. For example, the electronic device 100 may respectively compare a plurality of pieces of detailed information that the first AI model generates with respect to the plurality of pieces of recommended content 20.

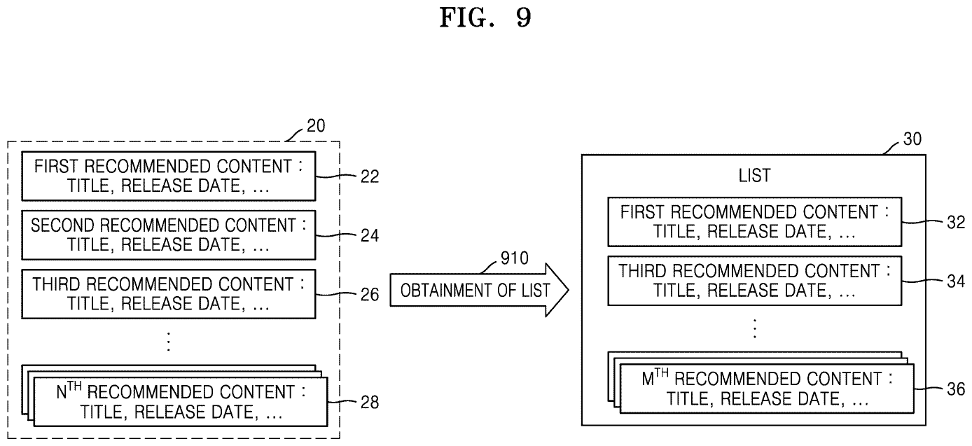

FIG. 9 is a diagram for describing an example of an operation in which an electronic device obtains a list, according to an embodiment of the disclosure.

According to an embodiment of the disclosure, the electronic device 100 may obtain the list 30, based on the plurality of pieces of recommended content 20 and the content database 140. The electronic device 100 may generate the list 30 by using a result of comparing the plurality of pieces of recommended content 20 with the content database 140 (810).

According to an embodiment of the disclosure, the electronic device 100 may compare the plurality of pieces of recommended content 20 with the content database 140, and thus, may identify whether each of the plurality of pieces of recommended content is stored in the content database 140. The electronic device 100 may identify whether information of the content database 140 which has the same attribute matches information of recommended content.

According to an embodiment of the disclosure, when the information of the content database 140 which has the same attribute matches the information of the recommended content, the electronic device 100 may determine that the recommended content is stored in the content database 140. The electronic device 100 may add, to the list 30, the recommended content determined to be stored in the content database 140.

For example, when it is identified that the first recommended content 22 is included in the content database 140, the electronic device 100 may add the first recommended content 22 to the list 30. The electronic device 100 may add information of the first recommended content 22 to the list 30. The list 30 may include first recommended content 32 and information of the first recommended content 32.

Also, for example, when it is identified that second recommended content 24 is not included in the content database 140, the electronic device 100 may add the second recommended content 24 to the list 30. The electronic device 100 may not add information of the second recommended content 24 to the list 30.

Also, for example, when it is identified that third recommended content 26 is included in the content database 140, the electronic device 100 may add the third recommended content 26 to the list 30. The electronic device 100 may add information of the third recommended content 26 to the list 30. The list 30 may include third recommended content 34 and information of the third recommended content 34.

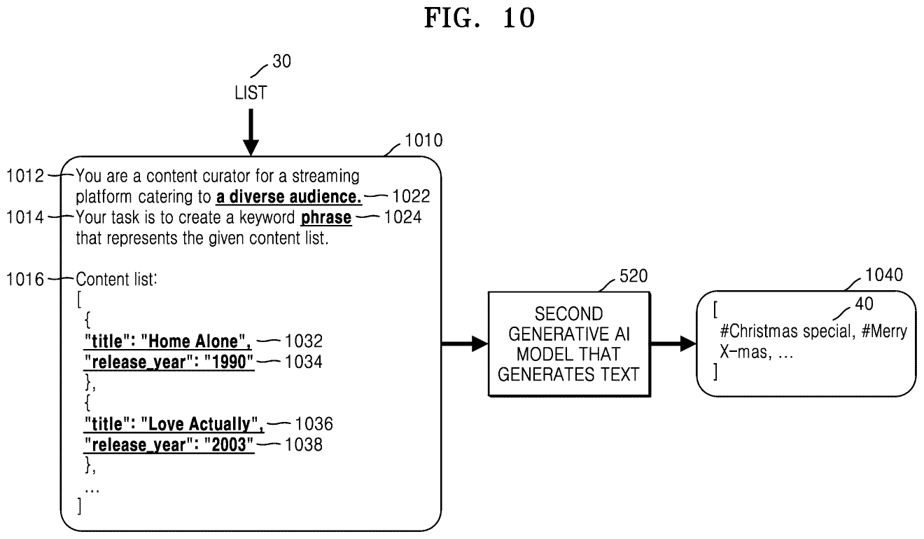

FIG. 10 is a diagram for describing an example of an operation in which an electronic device obtains a title corresponding to a list by inputting the list to a second AI model, according to an embodiment of the disclosure.

According to an embodiment of the disclosure, the electronic device 100 may input the list 30 to the second generative AI model 520. The electronic device 100 may generate a second input prompt 1010 for inputting the list 30 to the second generative AI model 520.

According to an embodiment of the disclosure, the second input prompt 1010 may include a command, an instruction, and an input which are based on text and are to be input to the second generative AI model 520.

According to an embodiment of the disclosure, the electronic device 100 may generate the second input prompt 1010 in a rule-based manner. For example, the electronic device 100 may generate the second input prompt 1010 for requesting generation of the title 40 corresponding to the list 30 by inserting the list 30 to a placeholder of a second prompt template. Alternatively, for example, the electronic device 100 may generate the second input prompt 1010 for requesting generation of the title 40 corresponding to the list 30 by inserting the list 30 and the target viewer information 70 to the placeholder of the second prompt template.

According to an embodiment of the disclosure, the second prompt template may be stored in the memory 130 of the electronic device 100. Alternatively, the electronic device 100 may receive the second prompt template from an external server.

According to an embodiment of the disclosure, the second prompt template may predefine and provide at least one of a command, an instruction, or an input with respect to a task to be performed by the second generative AI model 520. The placeholder may correspond to a predefined position to which the list 30 or the target viewer information 70 is inserted in the second prompt template. According to an embodiment of the disclosure, a placeholder to which the list 30 is to be mapped may be preset for each detailed information of recommended content included in the list 30.

For example, the second prompt template may include an instruction 1012. The instruction 1012 may include the target viewer information 70 that the second generative AI model 520 has to consider when performing a task of generating the title 40 corresponding to the list 30. For example, the instruction 1012 may include a placeholder 1022 designated for insertion of target viewer information.

Also, for example, the second prompt template may include a command 1014. The command 1014 may be a request for the second generative AI model 520 to perform a task of generating the title 40 corresponding to the list 30. The command 1014 may include a placeholder 1024 to which a type (e.g., a word, a phrase, a sentence, etc.) of the title 40 corresponding to the list 30 is to be inserted.

Also, for example, the second prompt template may include an indication 1016. The indication 1016 may include detailed information of recommended content included in the list 30 that has to be included when the second generative AI model 520 performs the ‘generating the title 40 corresponding to the list 30’ task. The indication 1016 may include a placeholder designated for insertion of the detailed information of the recommended content (e.g., a title of the recommended content or a release year of the recommended content).

For example, the indication 1016 may include a placeholder 1032 designated for insertion of a title of first recommended content. The indication 1016 may include a placeholder 1034 designated for insertion of a release year of the first recommended content. Also, for example, the indication 1016 may include a placeholder 1036 designated for insertion of a title of second recommended content. The indication 1016 may include a placeholder 1038 designated for insertion of a release year of the second recommended content.

According to an embodiment of the disclosure, the second generative AI model 520 may generate the title 40 corresponding to the list 30, based on the second input prompt 1010. For example, the second generative AI model 520 may perform a task of generating the title 40 corresponding to the list 30, according to a command or an instruction of the second input prompt 1010.

According to an embodiment of the disclosure, the second generative AI model 520 may perform a task of generating the title 40 corresponding to the list 30. For example, the second generative AI model 520 may generate a phrase, a theme message, description text, or a recommendation slogan which introduces recommended content included in the list 30.

According to an embodiment of the disclosure, the second generative AI model 520 may output result data 1040 including the title 40 corresponding to the list 30. The electronic device 100 may obtain the title 40 corresponding to the list 30 output from the second generative AI model 520.

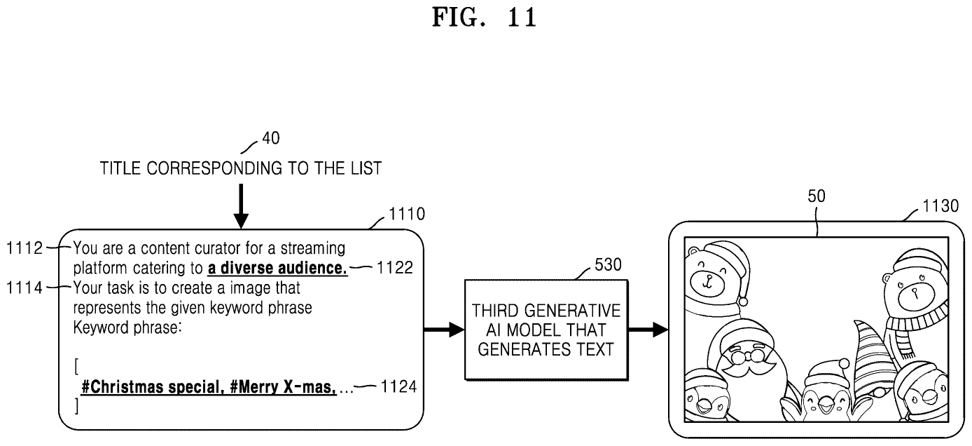

FIG. 11 is a diagram for describing an example of an operation in which an electronic device obtains an image by inputting a title corresponding to a list to a third AI model, according to an embodiment of the disclosure.

According to an embodiment of the disclosure, the electronic device 100 may input the title 40 corresponding to the list 30 to the third generative AI model 530. The electronic device 100 may generate a third input prompt 1110 for inputting the title 40 corresponding to the list 30 to the third generative AI model 530.

According to an embodiment of the disclosure, the third input prompt 1110 may include a command, an instruction, and an input which are based on text and are to be input to the third generative AI model 530.

According to an embodiment of the disclosure, the electronic device 100 may generate the third input prompt 1110 in a rule-based manner. For example, the electronic device 100 may generate the third input prompt 1110 for requesting generation of the image 50 by inserting the title 40 corresponding to the list 30 to a placeholder of a third prompt template. Alternatively, for example, the electronic device 100 may generate the third input prompt 1110 for requesting generation of the image 50 by inserting the title 40 corresponding to the list 30 and the target viewer information 70 to the placeholder of the third prompt template.

According to an embodiment of the disclosure, the third prompt template may be stored in the memory 130 of the electronic device 100. Alternatively, the electronic device 100 may receive the third prompt template from an external server.

According to an embodiment of the disclosure, the third prompt template may predefine and provide at least one of a command, an instruction, or an input with respect to a task to be performed by the third generative AI model 530. The placeholder may correspond to a predefined position to which title 40 corresponding to the list 30 or the target viewer information 70 is inserted in the third prompt template. According to an embodiment of the disclosure, a placeholder to which the title 40 corresponding to the list 30 is to be mapped may be preset.

For example, the third prompt template may include an instruction 1112. The instruction 1112 may include the target viewer information 70 that the third generative AI model 530 has to consider when performing a task of generating the image 50. For example, the instruction 1112 may include a placeholder 1122 designated for insertion of the target viewer information 70.

Also, for example, the third prompt template may include a command 1114. The command 1114 may be a request for the third generative AI model 530 to perform the task of generating the image 50. The command 1114 may include a placeholder 1124 to which title 40 corresponding to the list 30 is to be inserted.

According to an embodiment of the disclosure, the third generative AI model 530 may generate the image 50, based on the third input prompt 1110. For example, the third generative AI model 530 may perform the task of generating the image 50, according to a command or an instruction of the third input prompt 1110.

According to an embodiment of the disclosure, the third generative AI model 530 may perform the task of generating the image 50. For example, the third generative AI model 530 may generate an image that expresses the title 40 corresponding to the list 30.

According to an embodiment of the disclosure, the third generative AI model 530 may output a result 1130 including the image 50. The electronic device 100 may obtain the image 50 output from the third generative AI model 530.

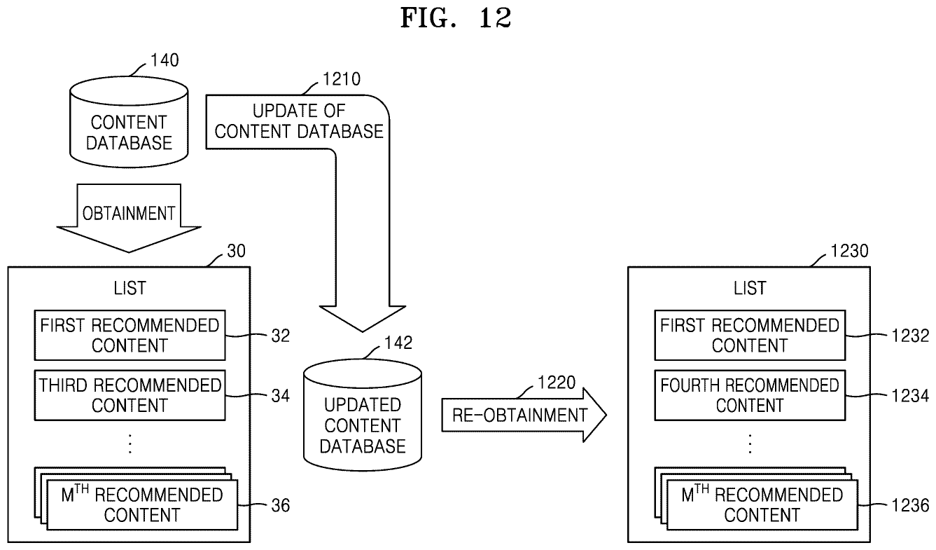

FIG. 12 is a diagram for describing an example of an operation in which an electronic device updates a list, according to an embodiment of the disclosure.

According to an embodiment of the disclosure, the electronic device 100 may obtain the list 30 based on the content database 140. When the content database 140 is updated (1210), the electronic device 100 may re-obtain a list 1230 (1220), based on an updated content database 142. The electronic device 100 may obtain the new list 1230 of content by updating the list 30.

For example, when the first recommended content 32 is included in the updated content database 142, the electronic device 100 may maintain first recommended content 1232 in the list 1230. For example, when the third recommended content 34 is not included in the updated content database 142, the electronic device 100 may remove the third recommended content 34 from the list 1230. Also, for example, when fourth recommended content 1234 is included in the updated content database 142, the electronic device 100 may add the fourth recommended content 1234 to the list 1230.

According to an embodiment of the disclosure, the electronic device 100 may re-obtain the plurality of pieces of recommended content 20 from a first AI model at every first interval. The electronic device 100 may update the plurality of pieces of recommended content 20 from the first AI model at every first interval. The first interval may be preset. For example, the first interval may be preset as 1 day.

According to an embodiment of the disclosure, the electronic device 100 may re-generate the list 30 based on the plurality of pieces of recommended content 20 at every first interval. The electronic device 100 may update the list 30 based on the plurality of pieces of recommended content 20 at every first interval.

According to an embodiment of the disclosure, the electronic device 100 may re-obtain the title 40 corresponding to the list 30 from a second AI model at every second interval. The electronic device 100 may update the title 40 corresponding to the list 30 from the second AI model at every second interval. The second interval may be preset. For example, the second interval may be set to be an interval being relatively longer than the first interval. For example, the second interval may be set as 3 days.

According to an embodiment of the disclosure, the electronic device 100 may re-obtain the image 50 from a third AI model at every third interval. The electronic device 100 may update the image 50 from the third AI model at every third interval. The third interval may be preset. For example, the third interval may be set to be an interval being relatively longer than the second interval. For example, the third interval may be set as 7 days.

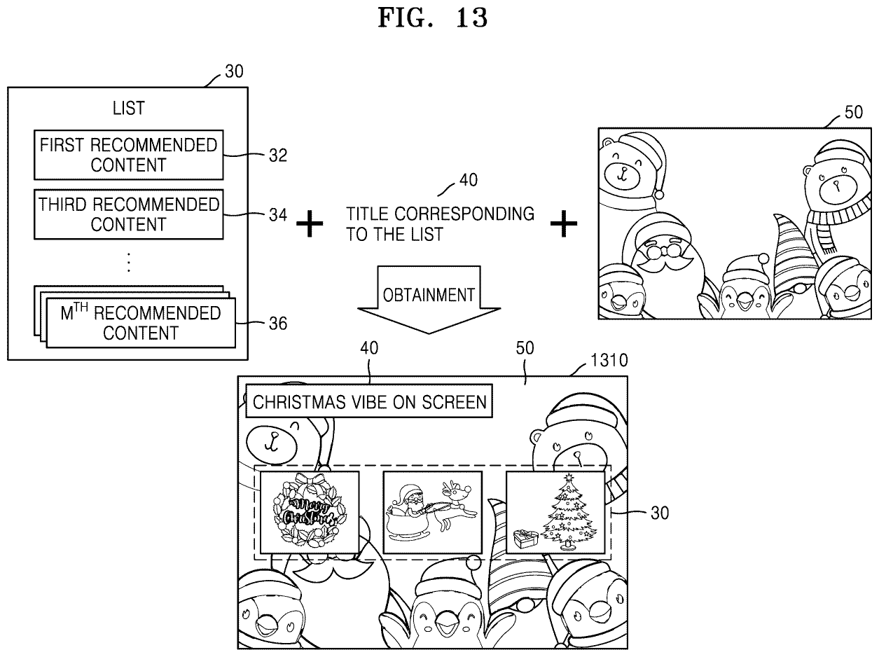

FIG. 13 is a diagram for describing an example of an operation in which an electronic device provides a list, a title corresponding to the list, and an image, according to an embodiment of the disclosure.

According to an embodiment of the disclosure, the electronic device 100 may provide the list 30, the title 40 corresponding to the list 30, and the image 50. According to a request of the display device 200, the electronic device 100 may transmit the list 30, the title 40 corresponding to the list 30, and the image 50 to the display device 200. For example, when receiving data from the display device 200, the electronic device 100 may transmit the list 30, the title 40 corresponding to the list 30, and the image 50 to the display device 200, based on the received data. The display device 200 may generate a recommended content image 1310 by combining the list 30, the title 40 corresponding to the list 30, and the image 50 by using an algorithm stored in the display device 200. The recommended content image 1310 may be an image including the list 30, the title 40 corresponding to the list 30, and the image 50. The display device 200 may display the recommended content image 1310 on a user interface of the display device 200.

According to an embodiment of the disclosure, the electronic device 100 may obtain the recommended content image 1310 by combining the list 30, the title 40 corresponding to the list 30, and the image 50. For example, the electronic device 100 may dispose the list 30 and the title 40 corresponding to the list 30 not to overlap on a display. The electronic device 100 may dispose the list 30 and the title 40 corresponding to the list 30 on an uppermost layer. The electronic device 100 may dispose the image 50 and the list 30 to overlap on the display. The electronic device 100 may dispose the image 50 and the title 40 corresponding to the list 30 to overlap on the display. The electronic device 100 may dispose the image 50 on a lowermost layer.

According to an embodiment of the disclosure, the electronic device 100 may provide the generated recommended content image 1310 to the display device 200, according to the request of the display device 200. When receiving data from the display device 200, the electronic device 100 may provide the display device 200 with the recommended content image 1310 generated based on the receive data.

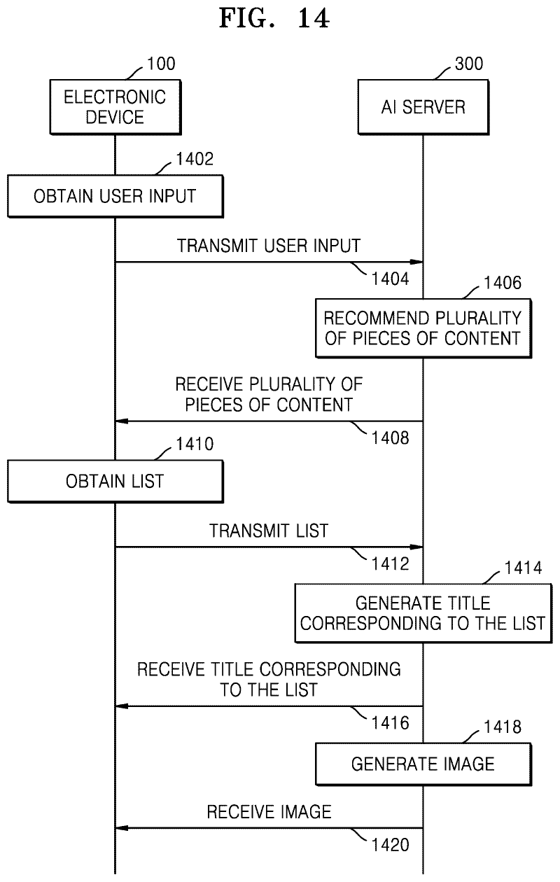

FIG. 14 is a diagram for describing an example of an operation of a system, according to an embodiment of the disclosure.

According to an embodiment of the disclosure, the electronic device 100 may obtain the user input 10 (1402). The electronic device 100 may transmit the user input 10 to the AI server 300 (1404). The electronic device 100 may receive the plurality of pieces of recommended content 20 from the AI server 300 (1408). The electronic device 100 may obtain the list 30, based on the plurality of pieces of recommended content (1410). The electronic device 100 may transmit the generated list 30 to the AI server 300 (1412). The electronic device 100 may receive the title 40 corresponding to the list 30 from the AI server 300 (1416). The electronic device 100 may receive the image 50 from the AI server 300 (1420).

According to an embodiment of the disclosure, the AI server 300 may receive the user input 10 from the electronic device 100. The AI server 300 may recommend a plurality of pieces of content (1406). The AI server 300 may transmit the plurality of pieces of recommended content 20 to the electronic device 100. The AI server 300 may receive the list 30 from the electronic device 100. The AI server 300 may generate the title 40 corresponding to the list 30 (1414). The AI server 300 may transmit the title 40 corresponding to the list 30 to the electronic device 100. The AI server 300 may generate the image 50 (1418). The AI server 300 may transmit the image 50 to the electronic device 100.

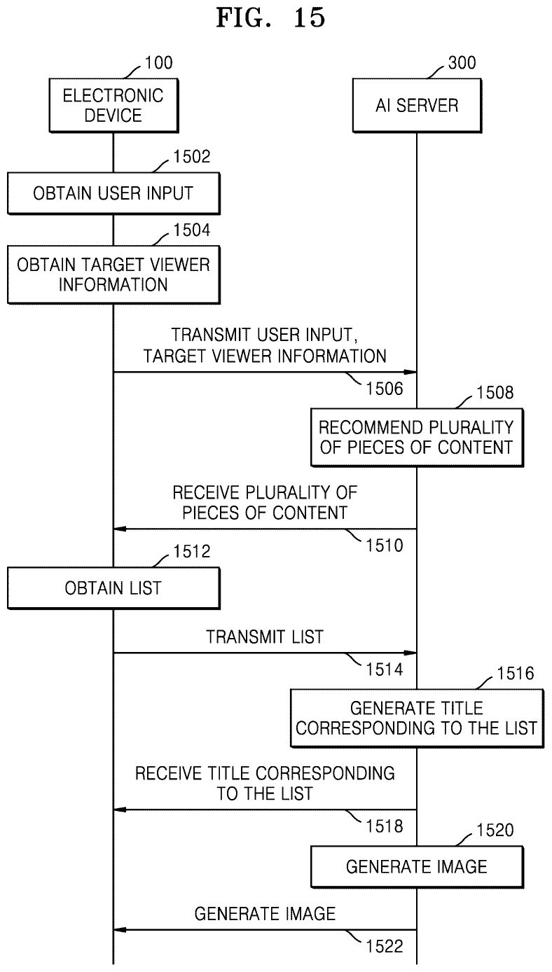

FIG. 15 is a diagram for describing an example of an operation of a system, according to an embodiment of the disclosure.

According to an embodiment of the disclosure, the electronic device 100 may obtain the user input 10 (1502). The electronic device 100 may obtain the target viewer information 70 (1504). The electronic device 100 may transmit the user input 10 to the AI server 300 (1506). The electronic device 100 may transmit the target viewer information 70 to the AI server 300 (1506). The electronic device 100 may receive the plurality of pieces of recommended content 20 from the AI server 300 (1510). The electronic device 100 may obtain the list 30, based on the plurality of pieces of recommended content (1512). The electronic device 100 may transmit the generated list 30 to the AI server 300 (1514). The electronic device 100 may receive the title 40 corresponding to the list 30 from the AI server 300 (1518). The electronic device 100 may receive the image 50 from the AI server 300 (1522).

According to an embodiment of the disclosure, the AI server 300 may receive the user input 10 from the electronic device 100. The AI server 300 may receive the target viewer information 70 from the electronic device 100. The AI server 300 may recommend a plurality of pieces of content (1508). The AI server 300 may transmit the plurality of pieces of recommended content 20 to the electronic device 100. The AI server 300 may receive the list 30 from the electronic device 100. The AI server 300 may generate the title 40 corresponding to the list 30 (1516). The AI server 300 may transmit the title 40 corresponding to the list 300 to the electronic device 100. The AI server 300 may generate the image 50 (1520). The AI server 300 may transmit the image 50 to the electronic device 100.

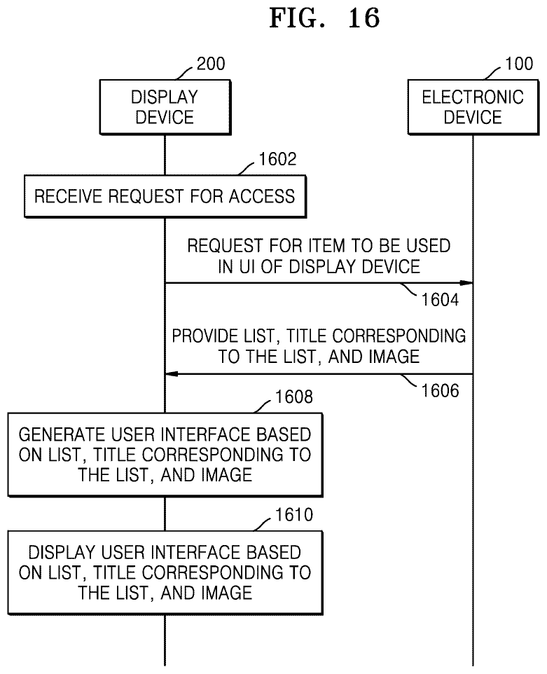

FIG. 16 is a diagram for describing an example of an operation of a system, according to an embodiment of the disclosure.

According to an embodiment of the disclosure, the electronic device 100 may receive a request for an item to be used in a user interface of the display device 200. The item to be used in the user interface of the display device 200 may include the list 30, the title 40 corresponding to the list 30, and the image 50. The electronic device 100 may provide the list 30, title 40 corresponding to the list 30, and the image 50 to the display device 200 (1606).

According to an embodiment of the disclosure, the display device 200 may receive a request for an access to the electronic device 100 from a user (1602). The display device 200 may request the electronic device 100 for the item to be used in the user interface of the display device 200 (1604). For example, the display device 200 may provide the electronic device 100 with data that requests the item to be used in the user interface. The item to be used in the user interface of the display device 200 may include the list 30, the title 40 corresponding to the list 30, and the image 50. The display device 200 may receive the list 30, the title 40 corresponding to the list 30, and the image 50 from the electronic device 100.

According to an embodiment of the disclosure, the display device 200 may generate a user interface based on the list 30, the title 40 corresponding to the list 30, and the image 50 (1608). For example, the display device 200 may generate the user interface by using an algorithm stored in the display device 200.

According to an embodiment of the disclosure, the display device 200 may provide the user interface generated based on the list 30, the title 40 corresponding to the list 30, and the image 50. For example, the display device 200 may display the user interface including the list 30, the title 40 corresponding to the list 30, and the image 50 (1610).

According to an embodiment of the disclosure, the electronic device 100 may generate the user interface of the display device 200, based on the list 30, the title 40 corresponding to the list 30 and the image 50. The electronic device 100 may provide the generated user interface to the display device 200.

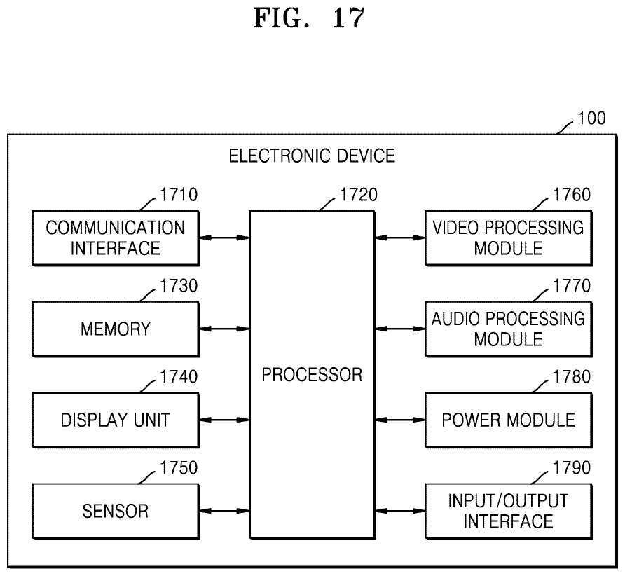

FIG. 17 is a block diagram for describing an example of a configuration of an electronic device according to an embodiment of the disclosure.

According to an embodiment of the disclosure, the electronic device 100 may include a communication interface 1710, at least one processor 1720, memory 1730, and a display unit 1740.

The communication interface 1710 may perform data communication with other electronic devices, under the control of the at least one processor 1720. The communication interface 1710 may include communication circuitry.

The communication interface 1710 may perform data communication between the electronic device 100 and other electronic devices (e.g., the display device 200, the AI server 300, etc.) by using at least one of data communication schemes including a wired LAN (e.g., Ethernet), a wireless LAN (e.g., Wi-Fi, a cellular network (e.g., 4G, 5G, etc.), Bluetooth, BLE, ZigBee, infrared Data Association (IrDA), NFC, RF communication, and other various types of known wireless/wired communication technologies.

The electronic device 100 may transmit/receive recommended content, a list, a title corresponding to the list, or an image to/from other electronic devices (e.g., the display device 200, the AI server 300, etc.) by using the communication interface 1710.

The at least one processor 1720 may control all operations of the electronic device 100. The at least one processor 1720 may include processing circuitry. For example, the at least one processor 1720 may execute one or more instructions of a program stored in the memory 1730 to control all operations in which the electronic device 100 provides a list, a title corresponding to the list, and an image. The at least one processor 1720 may correspond to one or more processors.

The at least one processor 1720 may each include, for example, at least one of a CPU, a microprocessor, a GPU, ASICs, DSPs, DSPDs, PLDs, FPGAs, an AP, an NPU, or a dedicated AI processor designed with a hardware structure specialized for processing an AI model, but the disclosure is not limited thereto.

Descriptions related to operations of the at least one processor 1720 are already provided with reference to the drawings, and thus, repeated descriptions are omitted here.

The memory 1730 may include various types of memory. The memory 1730 may include a flash memory, a hard disk, a multimedia card micro type memory, and a memory card (e.g., an SD or XD memory card), and may include a non-volatile memory including at least one of ROM, EEPROM, PROM, a magnetic memory, a magnetic disk, or an optical disc, and a volatile memory such as RAM or SRAM.

The memory 1730 may store one or more instructions and one or more programs which cause the electronic device 100 to provide a list, a title corresponding to the list, and an image.

The display unit 1740 may include at least one of a liquid crystal display, a thin film transistor-liquid crystal display, a light-emitting diode display, an organic light-emitting diode display, a flexible display, a three-dimensional (3D) display, or an electrophoretic display. According to a type of the display unit 1740, the display unit 1740 may include at least two displays. The display unit 1740 is implemented as a touch screen, the display unit 1740 may be used as an input device such as a user interface, as well as an output device.

The electronic device 100 may further include additional elements for performing operations of an aforementioned embodiment of the disclosure. For example, the electronic device 100 may further include one or more sensors 1750, a video processing module 1760, an audio processing module 1770, a power module 1780, an input/output interface 1790, or the like.

According to an aspect of the disclosure, a method of operating an electronic device is provided.

The method may include obtaining, based on a user input, a list based on a plurality of pieces of recommended content obtained from a first AI model.

The method may include obtaining, based on the obtained list, a title associated with the list from a second AI model.

The method may include obtaining, based on the title associated with the list, an image from a third AI model.

The method may include providing the list, the title associated with the list, and the image.

The first AI model may include a first generative AI model configured to generate text.

The obtaining of, based on the user input, the list based on the plurality of pieces of recommended content obtained from the first AI model may include obtaining information associated with each recommended content among the plurality of pieces of recommended content related to the user input, via the first generative AI model.

The information associated with each recommended content may include a respective title of each recommended content.

The information corresponding to each recommended content may include at least one of a platform corresponding to provision of content, a release date of content, a producer of content, a runtime of content, a genre of content, or information on performer of content.

The obtaining of, based on the user input, the list based on the plurality of pieces of recommended content obtained from the first AI model may include obtaining, based on the user input and target viewer information, via the first AI model, information associated with a subset of recommended content among the plurality of pieces of recommended content.

The subset of recommended content may comprise content for which a target viewer is considered and for which are related to the user input.

The target viewer information may include at least one of a gender of the target viewer, a platform used by the target viewer, or a genre preferred by the target viewer.

The obtaining of, based on the user input, the list based on the plurality of pieces of recommended content obtained from the first AI model may include, when each recommended content is included in a content database, adding each recommended content to the list.

The second AI model may include a second generative AI model configured to generate text.

The obtaining of, based on the obtained list, the title associated with the list from the second AI model may include obtaining the title associated with the list corresponding to the plurality of pieces of recommended content included in the list, via the second generative AI model, based on the list.

The third AI model may include a third generative AI model configured to generate an image.

The obtaining of, based on the obtained title, the image from the third AI model may include obtaining the image related to the title associated with the list, via the third generative AI model, based on the obtained title.

The providing of the list, the title associated with the list, and the image may include, when data is received from a display device, transmitting, based on the received data, the list, the title associated with the list, and the image to the display device.

At least one of the first AI model, the second AI model, or the third AI model may include a multi-modal AI model configured to generate an image and text.

According to an aspect of the disclosure, an electronic device is provided. The electronic device may include a communication interface, at least one processor including processing circuitry, and memory storing instructions, and the instructions may be executed by the at least one processor individually or collectively.

The at least one processor may obtain, based on a user input, a list based on a plurality of pieces of recommended content obtained from a first AI model.

The at least one processor may obtain, based on the obtained list, a title associated with the list from a second AI model.

The at least one processor may obtain, based on the title associated with the list, an image from a third AI model.

The at least one processor may provide the list, the title associated with the list, and the image.

The first AI model may include a first generative AI model configured to generate text.

The at least one processor may obtain information associated with each recommended content among the plurality of pieces of recommended content related to the user input, via the first generative AI model.

The information associated with each recommended content may include a respective title of each recommended content.

The information associated with each recommended content may include at least one of a platform associated with provision of content, a release date of content, a producer of content, a runtime of content, a genre of content, or information on performer of content,.

The at least one processor may obtain based on the user input and target viewer information, via the first AI model, information associated with a subset of recommended content among the plurality of pieces of recommended content.

The subset of recommended content may comprise content for which a target viewer is considered and for which are related to the user input.

The target viewer information may include at least one of a gender of the target viewer, a platform used by the target viewer, or a genre preferred by the target viewer.

When each recommended content is included in a content database, the at least one processor may add each recommended content to the list.

The second AI model may include a second generative AI model configured to generate text.

The at least one processor may obtain the title associated with the list corresponding to the plurality of pieces of recommended content included in the list, via the second generative AI model, based on the list.

The third AI model may include a third generative AI model configured to generate an image.

The at least one processor may obtain the image related to the title associated with the list, via the third generative AI model, based on the obtained title.

When data is received from a display device, the at least one processor may transmit, based on the received data, the list, the title associated with the list, and the image to the display device.

According to an aspect of the disclosure, a computer-readable recording medium having recorded thereon a program for executing the electronic device and/or any one of the methods described above and below of operating the electronic device may be provided.

A machine-readable storage medium may be provided in the form of a non-transitory storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

According to an embodiment of the disclosure, the method according to various embodiments of the present document may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user apparatuses (e.g., smartphones). In the case of online distribution, at least a portion of the computer program product (e.g., a downloadable application) may be at least temporarily stored or temporarily generated in a machine-readable storage medium such as a manufacturer's server, a server of an application store, or memory of a relay server.

What is claimed is:

1. A method of operating an electronic device, the method being executed by at least one processor, and the method comprising:
obtaining, based on a user input, a list based on a plurality of pieces of recommended content obtained from a first artificial intelligence (AI) model;
obtaining, based on the list, a title associated with the list from a second AI model;
obtaining, based on the title, an image from a third AI model; and
providing the list, the title associated with the list, and the image.

2. The method of claim 1, wherein the first AI model comprises a first generative AI model configured to generate text, and
wherein the obtaining of the list comprises:
obtaining, based on the user input, information associated with each recommended content among the plurality of pieces of recommended content related to the user input via the first generative AI model.

3. The method of claim 2, wherein the information associated with each recommended content comprises a respective title of each recommended content, and
at least one of:
a platform corresponding to provision of content,
a release date of content,
a producer of content,
a runtime of content,
a genre of content, or
information on performer of content.

4. The method of claim 2, wherein the obtaining of the list further comprises:
obtaining, based on the user input and target viewer information, via the first generative AI model, information associated with a subset of recommended content among the plurality of pieces of recommended content, wherein the subset of recommended content comprises content for which a target viewer is considered and for which are related to the user input.

5. The method of claim 4, wherein the target viewer information comprises at least one of a gender of the target viewer, a platform used by the target viewer, or a genre preferred by the target viewer.

6. The method of claim 2, wherein, the obtaining of the list comprises when each recommended content is comprised in a content database, adding each recommended content to the list.

7. The method of claim 1, wherein the second AI model comprises a second generative AI model configured to generate text, and
wherein the obtaining of the title comprises:
obtaining, based on the list, via the second generative AI model, the title associated with the list corresponding to the plurality of pieces of recommended content comprised in the list.

8. The method of claim 1, wherein the third AI model comprises a third generative AI model configured to generate an image, and
wherein the obtaining of the image comprises:
obtaining the image associated with the title associated with the list, based on the title, via the third generative AI model.

9. The method of claim 1, wherein the providing of the list, the title associated with the list, and the image comprises, when data is received from a display device, transmitting, based on the received data, the list, the title associated with the list, and the image to the display device.

10. The method claim 1, wherein at least one of the first AI model, the second AI model, or the third AI model comprises a multi-modal AI model configured to generate an image and text.

11. An electronic device comprising:
a communication interface;
at least one processor comprising processing circuitry; and
memory storing instructions,
wherein the instructions, when executed by the at least one processor individually or collectively, cause the electronic device to:
obtain, based on a user input, a list based on a plurality of pieces of recommended content obtained from a first artificial intelligence (AI) model;
obtain, based on the list, a title associated with the list from a second AI model;
obtain, based on the title, an image from a third AI model; and
provide the list, the title associated with the list, and the image.

12. The electronic device of claim 11, wherein the first AI model comprises a first generative AI model configured to generate text, and
wherein the instructions, when executed by the at least one processor, cause the electronic device to obtain, based on the user input, information associated with each recommended content among the plurality of pieces of recommended content related to the user input via the first generative AI model.

13. The electronic device of claim 12, wherein the information associated with each recommended content comprises a respective title of each recommended content, and
At least one of:
a platform corresponding to provision of content,
a release date of content,
a producer of content,
a runtime of content,
a genre of content, or
information on performer of content.

14. The electronic device of claim 12, wherein the instructions, when executed by the at least one processor, further cause the electronic device to obtain, based on the user input and target viewer information (70), via the first generative AI model, information associated with a subset of recommended content among the plurality of pieces of recommended content, the subset of recommended content comprising content for which a target viewer is considered and for which are related to the user input.

15. The electronic device of claim 14, wherein the target viewer information comprises at least one of a gender of the target viewer, a platform used by the target viewer, or a genre preferred by the target viewer.

16. The electronic device of claim 11, wherein the instructions, when executed by the at least one processor, further cause the electronic device to, when each recommended content is comprised in a content database, add each recommended content to the list.

17. The electronic device of claim 11, wherein the second AI model comprises a second generative AI model configured to generate text, and
wherein the instructions, when executed by the at least one processor, further cause the electronic device to obtain, based on the list, via the second generative AI model, the title associated with the list corresponding to the plurality of pieces of recommended content comprised in the list.

18. The electronic device of claim 11, wherein the third AI model comprises a third generative AI model configured to generate an image, and
the instructions, when executed by the at least one processor, further cause the electronic device to obtain the image associated with the title associated with the list, based on the title, via the third generative AI model.

19. The electronic device of claim 11, wherein the instructions, when executed by the at least one processor, further cause the electronic device to, when data is received from a display device, transmit, based on the received data, the list, the title associated with the list, and the image to the display device.

20. A non-transitory computer readable medium storing instructions that, when executed by at least one processor, cause the at least one processor to:
obtain, based on a user input, a list based on a plurality of pieces of recommended content obtained from a first artificial intelligence (AI) model;
obtain, based on the list, a title associated with the list from a second AI model;
obtain, based on the title, an image from a third AI model; and
provide the list, the title associated with the list, and the image.
